(19) United States
(12) Patent Application Publication
(10) Pub. No.: US 2023/0002115 A1
(43) Pub. Date: Jan. 5, 2023

(54) LOW-TEMPERATURE STORAGE CONTAINER

(71) Applicant: TSUBAKIMOTO CHAIN CO., Osaka (JP)

(72) Inventor: Masahiro ASUKAI, Osaka (JP)

(73) Assignee: TSUBAKIMOTO CHAIN CO., Osaka (JP)

(21) Appl. No.: 17/894,937

(22) Filed: Aug. 24, 2022

Related U.S. Application Data
(63) Continuation of application No. PCT/JP2020/047447, filed on Dec. 18, 2020.

(30) Foreign Application Priority Data
Mar. 11, 2020 (JP) 2020-041544

(51) Int. Cl. B65D 25/04; B65D 81/38

(52) U.S. Cl. CPC B65D 25/04; B65D 81/3837

(57) ABSTRACT

The present invention aims at providing a low-temperature storage container that is highly insulated and can therefore reduce the amount of cooling medium consumption. The low-temperature storage container of the present invention includes a cylindrical container body having an opening and a storage compartment, and a plurality of holding shelves provided in the storage compartment, on which storage trays for holding storage objects are placed. The storage compartment includes a plurality of holding zones arranged in a circumferential direction of the container body, where the storage trays are held, and at least one passage zone where the storage trays pass. The holding shelves are configured as parts of a plurality of rack units that are sections arranged in a circumferential direction of the container body.

### BACKGROUND OF THE INVENTION

### 1. Field of the Invention

The present invention relates to a low-temperature storage container that stores storage objects at low temperatures, and more particularly to a low-temperature storage container that stores samples for drug development used in the processes of discovering or designing drugs in medical science, bioengineering, and pharmaceutical sciences, at extremely low temperatures such as −190° C. obtained by use of liquid nitrogen or other cryogens.

### 2. Description of the Related Art

Low-temperature storage containers that store storage objects containing samples at low temperatures are commonly known (see, for example, Japanese Patent Application Publications Nos. 2015-205749 and 2016-88659). The container includes a cylindrical container body, with a storage compartment inside. A plurality of holding shelves, on which storage trays for holding storage objects are placed, are provided in the storage compartment of the container body.

In the low-temperature storage container described in Japanese Patent Application Publication No. 2015-205749 or No. 2016-88659, the plurality of holding shelves are configured as parts of rack members, each of which has a flat cylindrical wall part and a plurality of circumferentially equally spaced beam members extending radially inward from the inner circumferential surface of the wall. A plurality of such rack members are stacked up vertically so that the plurality of holding shelves are arrayed both circumferentially and vertically. The container body has a circular opening in a top wall part for allowing holding shelves to be carried into the storage compartment. This opening is of a size that allows the rack members to be carried into the storage compartment, i.e., has a diameter larger than the outside diameter of the wall parts of the rack members. The opening is closed by a lid that has a passage hole for storage trays to pass through. When assembling this low-temperature storage container, the plurality of rack members are brought into the storage compartment through the opening of the container body one after another and stacked up, after which the opening is closed by the lid.

### SUMMARY OF THE INVENTION

One problem with the low-temperature storage container described in Japanese Patent Application Publication No. 2015-205749 was that, because of the need for the significantly large opening in the top wall part of the container body to allow rack members to be brought into the storage compartment of the container body, the heat insulation of the entire low-temperature storage container was compromised even though the opening was closed with a highly insulating lid, leading to an increase in the amount of consumption of cooling medium such as liquid nitrogen used for the cooling.

The present invention was made on the basis of the circumstances described above, and it is an object of the invention is to provide a low-temperature storage container that is highly insulated and can therefore reduce the amount of cooling medium consumption.

The present invention solves the above problem by providing a low-temperature storage container including: a cylindrical container body having an opening and a storage compartment; and a plurality of holding shelves provided in the storage compartment, on which storage trays for holding storage objects are placed,

the storage compartment including a plurality of holding zones arranged in a circumferential direction of the container body, where the storage trays are held, and at least one passage zone where the storage trays pass,

the holding shelves being configured as parts of a plurality of rack units that are sections arranged in a circumferential direction of the container body.

According to the invention set forth in claim 1, the holding shelves are configured as parts of a plurality of rack units that are sections arranged in a circumferential direction of the container body. Therefore, the opening of the container body need only be large enough to allow each of the rack units to be brought into the storage compartment and can be made smaller. The low-temperature storage container as a whole can be highly insulated this way so that the amount of cooling medium consumption can be reduced.

According to the invention set forth in claim 2, the rack units include a plurality of beam members extending along side faces of storage trays. This further simplifies the structure of the holding shelves, and enables an operation of lifting up a storage tray placed on a holding shelf from below.

According to the invention set forth in claim 3, the rack units include a wall member disposed to face an inner circumferential surface of the container body, and the beam members extend inwards from the wall member. This allows the holding shelves to be configured simply in conformity with the internal cylindrical shape of the container body.

According to the invention set forth in claim 4, the rack units are configured as sections each corresponding to each of the holding zones, which enables a further reduction of the size of the opening of the container body. The beam members configured to be able to support a side portion along a radial direction of a storage tray in an adjacent holding zone can further simplify the configuration of the holding shelves.

According to the invention set forth in claim 5, the storage compartment is provided with a rotary table capable of holding the rack units placed thereon. When assembling the low-temperature storage container, after a rack unit is brought into the storage compartment through the opening of the container body and placed on the rotary table, the rotary table is rotated. This makes space for setting another rack unit directly below the opening. This way, the assembling of the low-temperature storage container is made easy.

According to the invention set forth in claim 6, the rotary table is rotatably supported on a rotation mechanism that is secured to a bottom part of the storage compartment, and the rotation mechanism is provided with a fixing mechanism that fixedly positions the rotation mechanism on the rotary table. Therefore the rotary table can be fixed in a predetermined position after all the rack units have been set on the rotary table.

According to the invention set forth in claim 7, the rack units include a base plate placed on the rotary table, and the base plate is provided with a fixing mechanism that fixedly positions the rack unit on the rotary table. Therefore the rack units can be stably set in predetermined positions on the rotary table.

According to the invention set forth in claim 8, a coupling member that couples the rack units adjoining each other is provided. Therefore the rack units can each be fixed to predetermined positions relative to each other, which facilitates the assembling of the low-temperature storage container.

### BRIEF DESCRIPTION OF THE DRAWINGS

FIG. 1 is a perspective view illustrating an outer appearance of a low-temperature storage container according to the present invention;

FIG. 2 is a cross-sectional view cut along an axial direction of the container body of the low-temperature storage container shown in FIG. 1;

FIG. 3 is a cross-sectional view cut along a plane perpendicular to the axial direction of the container body of the low-temperature storage container shown in FIG. 1;

FIG. 4 is a perspective view illustrating the configuration of an internal part of the container body of the low-temperature storage container shown in FIG. 1;

FIG. 5 is a plan view illustrating a support substrate in a rack unit to a larger scale;

FIG. 6 is an illustrative view showing a fixing mechanism that fixedly positions a rack unit on a rotary table;

FIG. 7 is a plan view illustrating a beam member, a support part, and an auxiliary support part in a rack unit to a larger scale;

FIG. 8 is a plan view illustrating a beam member, a support part, and an auxiliary support part in a rack unit adjacent to a passage zone to a larger scale;

FIG. 9 is a perspective view showing a fixing mechanism that fixedly positions the rotary table on a rotation mechanism;

FIG. 10 is an illustrative view showing guide rollers provided to the rotary table;

FIG. 11 is a perspective view illustrating the structure of the rotation mechanism; and

FIG. 12A to FIG. 12E are illustrative views illustrating steps of assembling the low-temperature storage container according to the present invention.

### DESCRIPTION OF THE PREFERRED EMBODIMENT

A low-temperature storage container according to one embodiment of the present invention is described below with reference to the drawings.

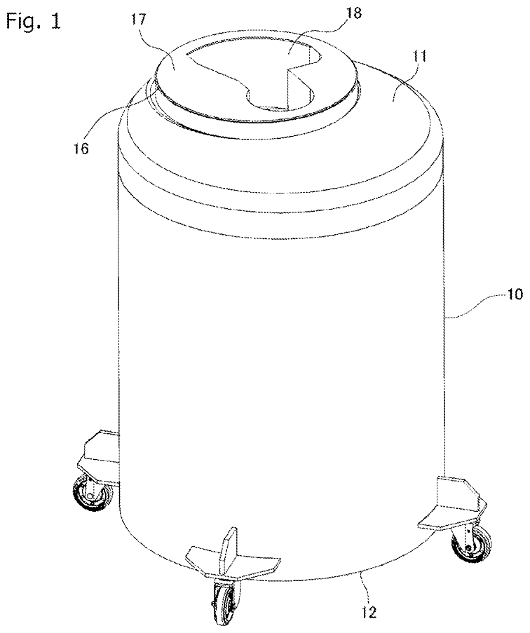

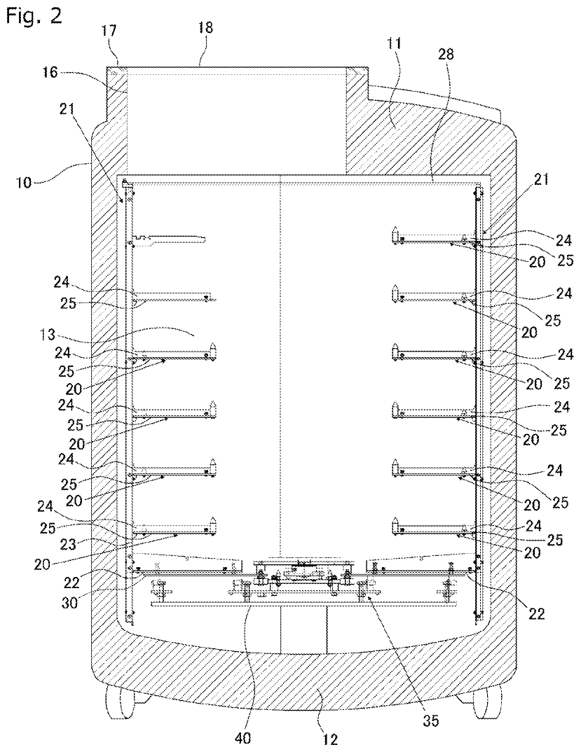

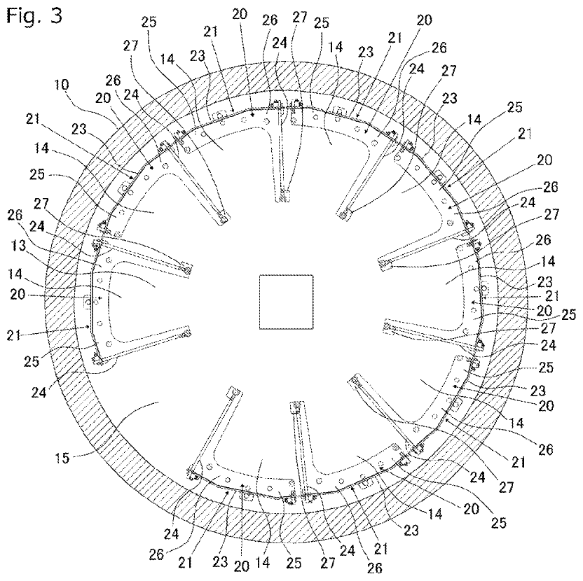

FIG. 1 is a perspective view illustrating an outer appearance of a low-temperature storage container according to the present invention. FIG. 2 is a cross-sectional view cut along an axial direction of the container body of the low-temperature storage container shown in FIG. 1. FIG. 3 is a cross-sectional view cut along a plane perpendicular to the axial direction of the container body of the low-temperature storage container shown in FIG. 1. FIG. 4 is a perspective view illustrating the configuration of an internal part of the container body of the low-temperature storage container shown in FIG. 1. This low-temperature storage container stores storage objects under extremely low temperatures such as −197° C. obtained by use of liquid nitrogen injected into the container, and includes a cylindrical container body 10 having a top wall part 11 and a bottom wall part 12, and a plurality of holding shelves 20 provided in a storage compartment 13 of the container body 10, on which fan-shaped storage trays for holding storage objects are placed.

Storage objects are accommodated inside the storage compartment 13 of the container body 10. This storage compartment 13 has a plurality of holding zones 14 arranged in a circumferential direction of the container body 10, where storage trays are held, and one passage zone 15 for storage trays to pass through. The top wall part 11 of the container body 10 is formed with a circular opening 16 that connects to the storage compartment 13. This opening 16 is of a size that allows entrance of rack units 21 to be described later. The opening 16 is closed by a lid 17 that has a passage hole 18 for storage trays to pass through. The passage hole 18 of the lid 17 can be opened and closed by a door (not shown) for the passage hole.

The plurality of holding shelves 20 are configured as parts of a plurality of rack units 21 that are sections arranged in a circumferential direction of the container body 10. The rack units 21 in the illustrated example are sections each corresponding to each of the holding zones 14. The rack units 21 are each placed on a circular disc-like rotary table 30 and circumferentially aligned such that each rack unit is located in a corresponding holding zone 14.

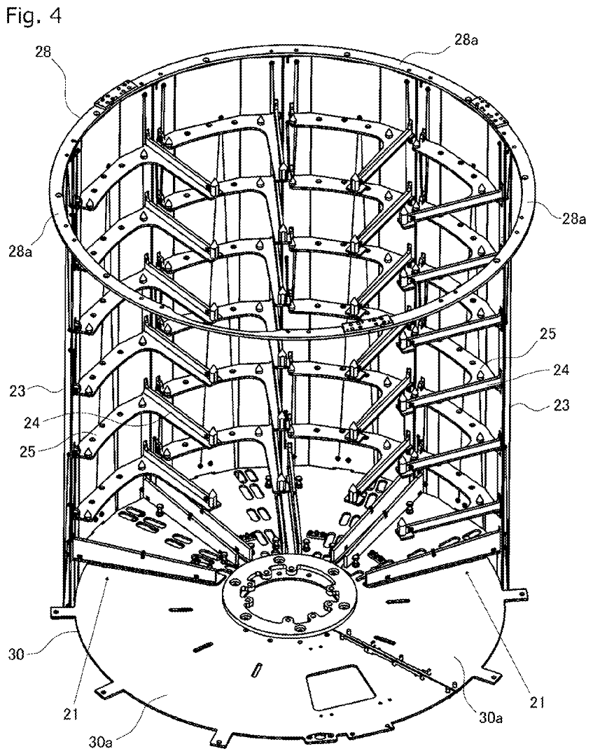

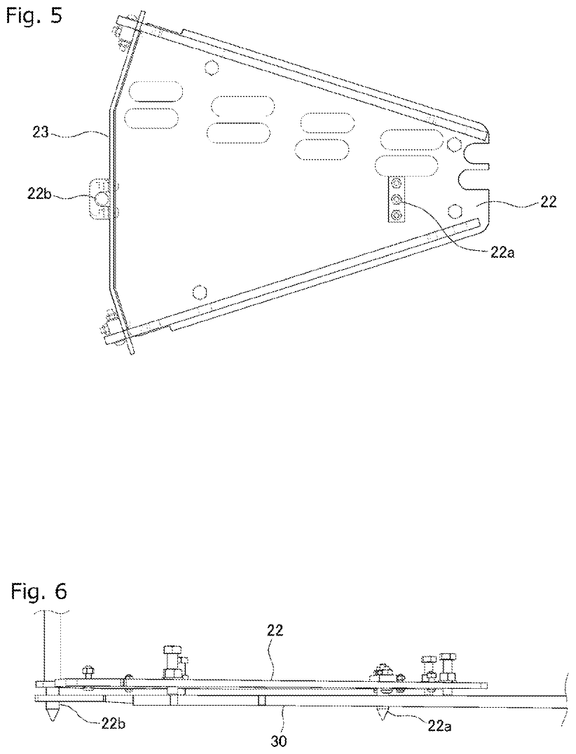

A base plate 22, which is substantially fan-shaped in plan view as shown also in FIG. 5 to a larger scale, is provided to the rack unit 21. This base plate 22 has a fixing mechanism with pins 22a and 22b that fixedly position the rack unit 21 on the rotary table 30, as shown also in FIG. 6, so that the rack units 21 are disposed at predetermined positions relative to the rotary table 30.

A vertically extending wall member 23 is secured to a circular arc edge portion of the base plate 22. This wall member 23 is made of a material having a high heat conductivity such as aluminum and cooled by a cooling medium such as liquid nitrogen contained at the bottom of the container body 10 so that the entire storage compartment 13 can be cooled evenly.

The wall member 23 has a plurality of beam members 24 extending along side faces of storage trays. To be more specific, the plurality of beam members 24 are equally spaced in the up and down direction, and extend from the wall member 23 radially inward of the container body 10. These beam members 24 are disposed to line up along the wall member 23 in the up and down direction.

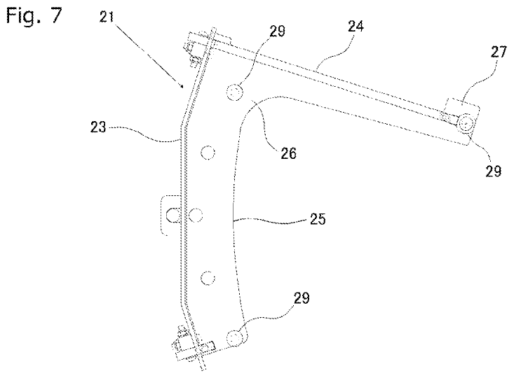

The beam members 24 are each provided with a shelf plate 25, as shown also in FIG. 7 to a larger scale. This shelf plate 25 includes a support part 26 that supports the underside of a storage tray along a side face in the radial direction and a side face in the circumferential direction, and an auxiliary support part 27 that supports the underside of a storage tray placed in an adjacent rack unit 21 along a side face in the radial direction.

To be more specific, the support part 26 of the shelf plate 25 is formed such as to protrude from the wall member 23 and the beam member 24 in the shape of letter L into a holding zone 14 where this rack unit 21 is located. The auxiliary support part 27 protrudes from the beam member 24 in a tongue-like shape into a holding zone 14 where an adjacent rack unit 21 is located. A holding shelf 20 is made up of the support part 26, and the auxiliary support part 27 of an adjacent rack unit 21. Positioning pins 29 are provided in a distal end portion of the beam member 24 and in the support part 26 of the shelf plate 25 for positioning the storage tray that is placed on the holding shelf 20. A storage tray can thus be placed reliably at a predetermined position on a holding shelf 20.

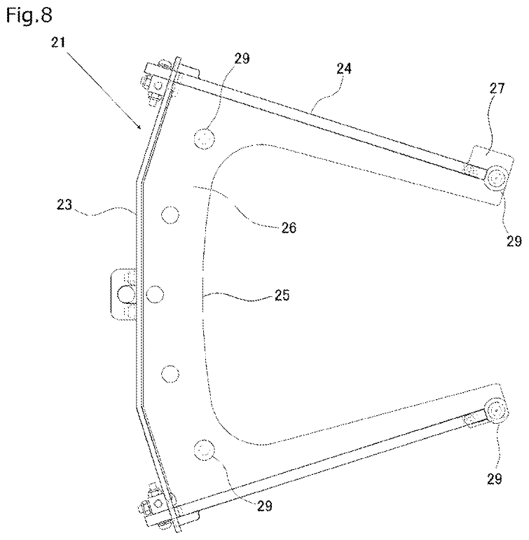

The rack unit 21 disposed in one of the two holding zones 14 adjacent the passage zone 15 has two beam members 24, spaced away from each other in the circumferential direction of the container body 10, as shown also in FIG. 8 to a larger scale. The support part 26 is formed such as to protrude from the wall member 23 and two beam members 24 in the shape of letter U into the holding zone 14 where this rack unit 21 is located. This support part 26 makes part of the holding shelf 20.

A ring-like coupling member 28 that connects the rack units 21 adjoining each other is provided to the upper end of the wall members 23 of respective rack units 21. The rack units 21 can thus be fixed in their predetermined positions relative to each other. The coupling member 28 is configured to be separable into a plurality of (e.g., three) coupling member elements 28a so that the coupling member 28 can be brought into the container body 10 through the opening 16 by splitting it into coupling member elements 28a.

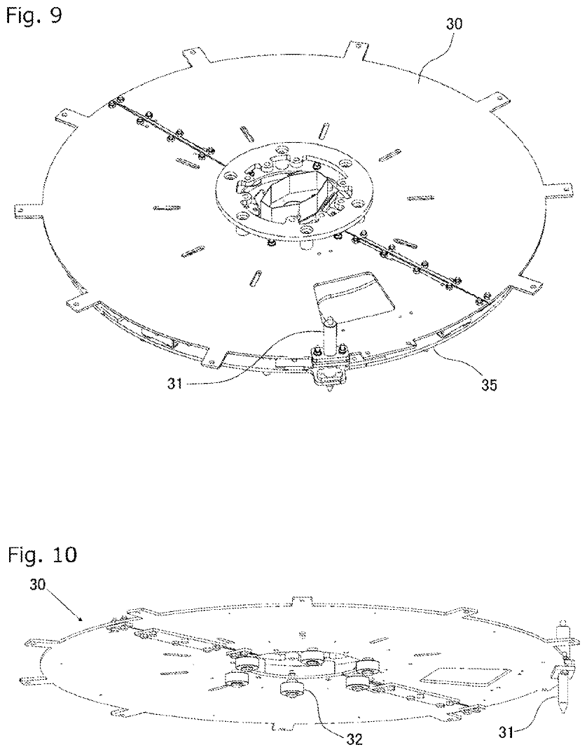

The rotary table 30 is made up of two semicircular table elements 30a connected together. The rotary table 30 can be brought into the container body 10 through the opening 16 by splitting it into table elements 30a. A rotation mechanism 35 for rotating the rotary table 30 is disposed below the rotary table 30. This rotation mechanism 35 is fixed on a support platform 40 provided in the bottom wall part 12 of the container body 10. As shown in FIG. 9, a fixing mechanism 31 with a pin for fixedly positioning the rotary table 30 on the rotation mechanism 35 is provided so that the rotary table 30 is fixed at a predetermined position relative to the rotation mechanism 35.

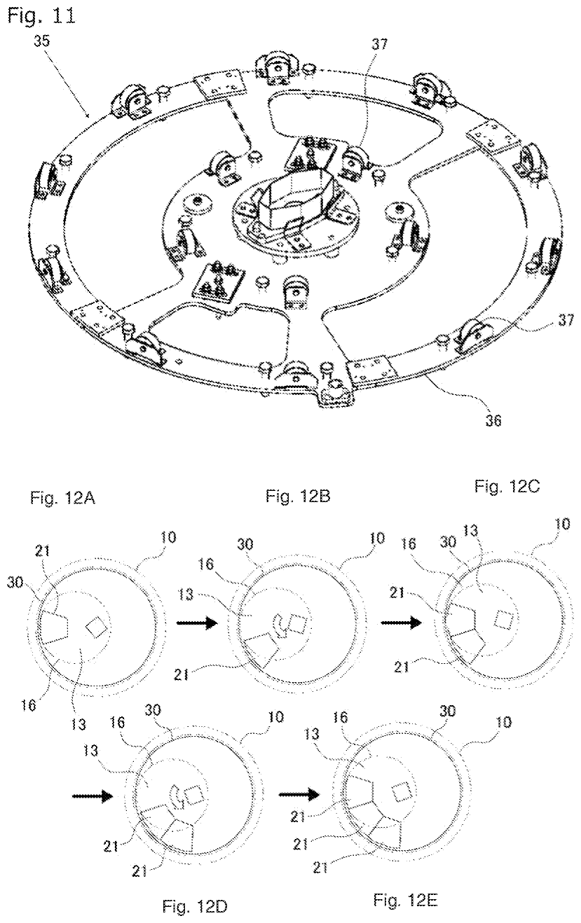

As shown in FIG. 10, a plurality of circumferentially equally spaced guide rollers 32 are provided on the underside of the rotary table 30 to rotate the rotary table 30 around a tubular shaft of the container body 10 as the center axis. The rotation mechanism 35 includes, as shown in FIG. 11, a plurality of circumferentially equally spaced rollers 37 disposed on a support body 36 for rotating the rotary table 30.

Rack units 21 are brought into the container body 10 of the low-temperature storage container described above in the following manner. As shown in FIG. 12A, a first rack unit 21 is carried into the storage compartment 13 through the opening 16 of the container body 10 and placed on the rotary table 30 directly below the opening 16. Next, as shown in FIG. 12B, the rotary table 30 is rotated in a predetermined direction (counterclockwise in the example of FIG. 12B) to make space directly below the opening 16. After that, as shown in FIG. 12C, a second rack unit 21 is carried into the storage compartment 13 through the opening 16 of the container body 10 and placed on the rotary table 30 directly below the opening 16. Then, as shown in FIG. 12D and FIG. 12E, the rotary table 30 is rotated in a predetermined direction (counterclockwise in the example of FIG. 12D) to make space directly below the opening 16, after which a third rack unit 21 is carried into the storage compartment 13 through the opening 16 of the container body 10 and placed on the rotary table 30 directly below the opening 16. The rack units 21 can be placed on the rotary table 30 by repeating this operation for all the rack units 21.

While one embodiment of the low-temperature storage container of the present invention has been described above, the present invention is not limited to the embodiment described above and various changes may be made.

For example, the opening 16 of the container body 10 is not limited to the circular shape and various other shapes can be adopted as long as rack units 21 can be carried into the storage compartment 13.

As long as the rack units 21 are circumferential sections in the container body 10, they need not necessarily be configured to each correspond to each of the holding zones. For example, one section may extend over a plurality of holding zones.

What is claimed is:

1. A low-temperature storage container comprising: a cylindrical container body having an opening and a storage compartment; and a plurality of holding shelves provided in the storage compartment, on which storage trays for holding storage objects are placed,
the storage compartment including a plurality of holding zones arranged in a circumferential direction of the container body, where the storage trays are held, and at least one passage zone where the storage trays pass,
the holding shelves being configured as parts of a plurality of rack units that are sections arranged in a circumferential direction of the container body.

2. The low-temperature storage container according to claim 1, wherein the rack units include beam members extending along side faces of the storage trays.

3. The low-temperature storage container according to claim 2, wherein the rack units include a wall member disposed to face an inner circumferential surface of the container body,
the beam members extending inward from the wall member.

4. The low-temperature storage container according to claim 3, wherein the rack units are configured as sections each corresponding to each of the holding zones,
the beam members being configured to be able to support a side portion along a radial direction of a storage tray in an adjacent holding zone.

5. The low-temperature storage container according to claim 1, wherein the storage compartment is provided with a rotary table capable of holding the rack units placed thereon.

6. The low-temperature storage container according to claim 5, wherein the rotary table is rotatably supported on a rotation mechanism that is secured to a bottom part of the storage compartment,
the rotation mechanism being provided with a fixing mechanism that fixedly positions the rotary table.

7. The low-temperature storage container according to claim 5, wherein the rack units include a base plate that is placed on the rotary table,
the base plate being provided with a fixing mechanism that fixedly positions the rack unit on the rotary table.

8. The low-temperature storage container according to claim 1, further comprising a coupling member that couples the rack units adjoining each other.
